(19) United States
(12) Patent Application Publication
(10) Pub. No.: US 2009/0047062 A1
(43) Pub. Date: Feb. 19, 2009

(54) QUICK RELEASE GUIDE STUD

(75) Inventors: Eric L. Storm, Naperville, IL (US); David S. Esbrook, Bloomingdale, IL (US)

Correspondence Address: SCHWABE, WILLIAMSON & WYATT, P.C., 1420 FIFTH, SUITE 3010, SEATTLE, WA, 98101, US

(73) Assignee: International Engine Intellectual Property Company, LLC, Warrenville, IL (US)

(21) Appl. No.: 11/837,731

(22) Filed: Aug. 13, 2007

(51) Int. Cl. F16B 21/09

(52) U.S. Cl. 403/118; 403/13; 269/47

(57) ABSTRACT

A guide stud (10, 110) for quick insertion and withdrawal from a tapped hole includes a shaft (12), a pin (14) concentrically disposed with respect to the shaft, and a spring (52) configured to apply force on the shaft to reciprocate the pin with respect to the shaft in an extended and a retracted position. A resilient gripper (58, 158) extends axially with respect to the shaft (12), the gripper having an outer surface (66, 166) having a rest-state diameter (D) and a deformed-state diameter (DD) that is larger than the rest-state diameter. The outer surface (66, 166) is deformable to the deformed-state diameter (DD) when the pin (14) is in the retracted position.

### FIELD OF THE INVENTION

The present invention relates generally to a guide stud for guiding the assembly of various components. More specifically, the present invention relates to a guide stud that is quickly insertable and releasable into a tapped hole.

### BACKGROUND OF THE INVENTION

A conventional guide stud is a threaded fastener that is inserted into a tapped hole and is used to guide the assembly of components, such as components with bolted joints. Typically, the guide stud is threaded into the tapped hole and acts as a temporary placeholder to position components relative to each other. When the components are fastened together, the guide stud is unthreaded from the tapped hole.

A disadvantage of the conventional guide stud is that the stud has to be threaded and unthreaded during assembly, which is time consuming and requires effort on the part of the user. Another disadvantage of the conventional guide stud is that tools may be required to thread and unthread the guide stud from the tapped hole. Moreover, use of tools can be problematic in applications where there is inadequate room to manipulate the tools. One example of an automotive application, where there are small clearances available during assembly, is during the assembly of a power steering pump.

### SUMMARY OF THE INVENTION

A guide stud includes a shaft, a pin concentrically disposed with respect to the shaft, and a spring configured to apply force on the shaft to reciprocate the pin with respect to the shaft in an extended and a retracted position. A resilient gripper extends axially with respect to the shaft, the gripper having an outer surface having a rest-state diameter and a deformed-state diameter that is larger than the rest-state diameter. The outer surface is deformable to the deformed-state diameter when the pin is in the retracted position.

### BRIEF DESCRIPTION OF THE DRAWINGS

FIG. 1 is a partial cross-sectional view of a first embodiment of guide stud in accordance with the invention.

FIG. 2 is a partial cross-sectional view of a second embodiment of guide stud in accordance with the invention.

### DESCRIPTION OF A PREFERRED EMBODIMENT

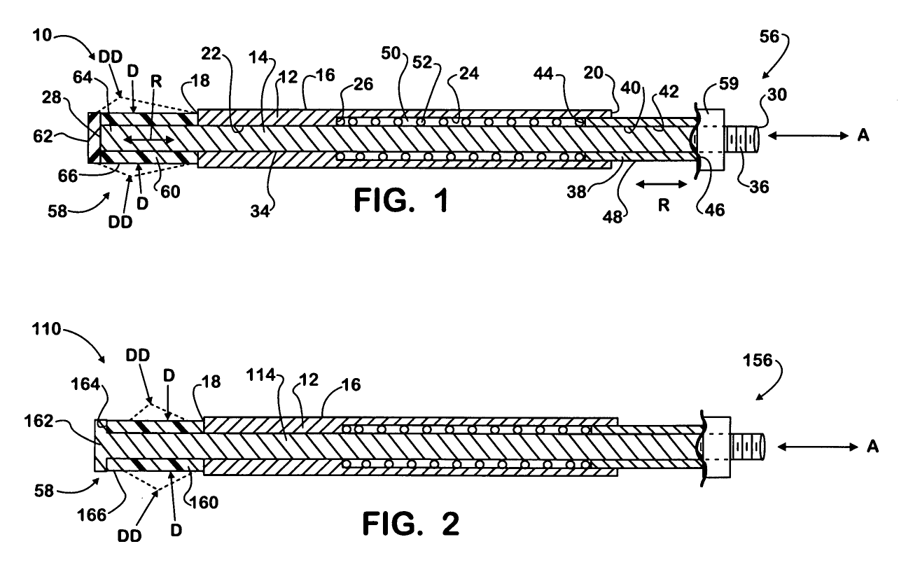

A cross-section view of a guide stud, depicted generally at 10, is shown in FIG. 1. The guide stud 10 includes a shank 12 and a pin 14 that is disposed inside the shank 12. It should be understood that while two embodiments will be shown and described, that there are many different configurations of alignment guide studs that are contemplated, in accordance with the invention.

The shank 12 is generally tubular with an outer surface 16, and has a first end 18 and a second end 20. At the first end 18, a first, annular inner surface 22 has a first diameter, and at the second end 20, a second, annular inner surface 24 has a second diameter that is larger than the first diameter. A seat surface 26 separates the first and the second inner surfaces 22, 24, and the first surface is advantageously smooth to permit the relative motion of the pin 14 within the shank 12.

The pin 14 has a centerline along an axis, A, and includes a first end 28 and a second end 30. The pin 14 is concentrically disposed inside the shank 12. Advantageously, the pin 14 is made of steel or similar material, but other suitable materials are contemplated. The pin 14 has an outer surface 34 that is generally cylindrical. A threaded portion 36 is disposed on the outer surface 34 of the pin 14 at the second end 30, and extends towards the first end 28. The threaded portion 36 extends along a portion of the pin 14 and the remainder of the pin is smooth. It is contemplated that the threaded portion 36 can extend along any portion of the length of the pin 14, and further, the threaded portion can extend along the entire length of the pin.

A pin sleeve 38 is concentrically disposed around the pin 14 at a sleeve receiving portion 40 of the pin 14. The sleeve-receiving portion 40 of the pin 14 is located closer to the second end 30 than to the first end 28 of the pin. An inner surface 42 of the pin sleeve 38 engages the pin 14 with a clearance fit.

The pin sleeve 38 is generally tubular and has a first end 44, a second end 46, and an outer surface 48. The outer diameter of the outer surface 48 is slightly less than the diameter of the second inner surface 24 of the shank 12. In this configuration, the pin sleeve 38 is slideably received in the second inner surface 24 of the shank 12.

The pin sleeve 38, the second inner surface 24, and the seat surface 26 form a pocket 50 that is generally concentrically disposed around the axis “A”. When the pin 14 is disposed in the pocket 50, the remaining space of the pocket is generally annular. Sitting within the remaining portion of the pocket 50 and generally concentrically disposed around the pin 14 is a spring 52. The spring 52 is seated on the seat surface 26 and pushes on the pin sleeve 38 at the first end 44.

A spring adjuster 54, advantageously a knurled knob, a nut, or another screw clamp, is disposed around the pin 14 at the threaded portion 36. The spring adjuster 54 is displaceable in the axial direction by rotating the adjuster about the pin 14 on the threaded portion 36. The spring adjuster 54 abuts the pin sleeve 38. The pin sleeve 38 is not attached to the spring adjuster 54, however it is contemplated that the pin sleeve and the spring adjuster can be attached or integrally formed. Further, it is contemplated that the pin sleeve 38 has a smooth inner surface 42.

Together, the pin 14, the pin sleeve 38 and the spring adjuster 54 form a plunger assembly 56 that is displaceable against the force of the spring 52 (the arrow labeled “R” in FIG. 1 indicates the direction of reciprocal motion of the plunger assembly). The pin sleeve 38 pushes on the spring adjuster 54, which is anchored to the pin 14, at times when the spring 52 pushes on the first end 44 of the pin sleeve 38. Thus, the force of the spring 52 pushes and displaces the plunger assembly 56 away from the second end 20 of the shank 12. The plunger assembly 56 can be depressed by the user to overcome the force of the spring 52 and to displace the plunger assembly towards the second end 20 of the shank 12.

The spring adjuster 54 adjusts a compression force that is exerted by the spring 52 onto the plunger assembly 56. Also, the spring adjuster 54 adjusts the length of the pin 14 that can be plunged concentrically into the shank 12.

Extending generally axially outwardly from the first end 18 of the shank 12 is a gripper 58, which is advantageously a tubular body 60. The tubular body 60 is attached at or adjacent to the first end 18 of the shank 12, but other configurations are contemplated. The gripper 60 includes a generally circular head 62 attached to or integrally formed with the tubular body 60. The head 62 forms a receiving structure 64 for receiving the plunger assembly 56. In the guide stud 10, the receiving structure 64 is a cavity that receives the pin 14, however other configurations of receiving structures 34 are contemplated. Advantageously, the pin 14 is attached to the head 62.

The gripper 58 is made of a generally resilient material, such as polyurethane or other plastics, natural or synthetic rubber, or any other material exhibiting resilient, elastic material behavior. The gripper 58 is advantageously deformable, having a rest-state outer diameter “D”, and a deformed-state outer diameter (shown schematically in dashed lines “DD”). While an outer surface 66 is generally smooth and cylindrical in the rest-state, the outer surface has a deformation or “bulge” that makes the deformed-state outer diameter larger than the rest-state outer diameter while in the deformed-state.

When the guide stud 10 is inserted into a tapped hole (not shown), the user depresses the plunger assembly 56 and pushes the pin 14 against the receiving structure 64 of the gripper 58. The pin 14 displaces away from the shank 12 onto the head 62, which applies tension along the gripper 58, which in turn causes the outer surface 66 to have the small outer diameter “D”. With the smaller outer diameter “D”, the guide stud 10 is slip fit into the tapped hole.

When the guide stud 10 is disposed at least partially into the tapped hole, the user releases the plunger assembly 56 causing the pin 14 to retract with respect to the first end 18 of the shank 12. When the plunger assembly 56 is released, the spring 52 causes the pin 14 to pull on the gripper 58 at the head 62, thus deforming the tubular body 60. The “bulging” deformation of the tubular body 60 increases the outer diameter thereof to “DD” and engages the tapped hole. The diameter “DD” is larger than the outer diameter of the shank 12 such that the gripper 58 grips the sides of the tapped hole in an interference clearance fit. In this position, the guide stud 10 can be used to guide the assembly of a bolted joint.

When the user desires to quickly remove the guide stud 10, the user depresses the plunger assembly 56. Depression of the plunger assembly 56 causes the plunger end 30 to move axially toward the second end 20 of the shank 12. This motion displaces the pin 14 axially away from the first end 18 of the shank 12 and applies tension along the gripper 58. The tension along the gripper 58 causes the outer surface 66 to regain the small outer diameter “D” and resume a slip fit with the tapped hole.

An alternate embodiment for a guide stud, indicated generally at 110, is shown in FIG. 2. The guide stud 110 is generally similar to the guide stud 10. For the sake of simplicity, like components are denoted with similar numbering in the 100-series. The main difference between the embodiments 10 and 110 is the construction of the gripper 158 and the pin 114.

In this embodiment, a head 162 is integrally formed on the pin 114. The head 162 forms a general “T”-shape with the pin 114. A gripper 158 is concentrically disposed around the pin 114, and has a generally tubular body 160. The gripper 158 includes a receiving structure 164 configured for engagement with the pin 114. The receiving structure 164 is a distal-end surface of the tubular body of the gripper 158 that is disposed on the opposite end from the shank 12. It is contemplated that the gripper 158 may be either attached to or separate from the head 162.

When the guide stud 110 is used in a tapped hole formed in a receiving component (not shown), the user depresses a plunger assembly 156, which moves the pin 114 away from the first end 18 of the shank 12. The pin 114 displaces away from the first end 18 of the shank 12, which applies tension along the gripper 158, which in turn, causes an outer surface 166 to have the small outer diameter “D”. Alternately, if the distal end of the gripper 158 is not attached to the head 162, then the outward displacement of the pin 114 away from the shank 12 permits the resilient gripper to resume a rest-state with a small outer diameter “D”.

Then, the user releases the plunger assembly 156, causing the pin 114 to retract towards the first end 18 of the shank 12, thus causing the head 162 to push against the receiving structure 164. The pin 114 pushes the receiving structure/distal-end 164 of the gripper 162 causing the gripper 162 to deform and achieve an outer diameter “DD”. In this position, the stud guide 110 is retained in the tapped hole by an interference fit therewith.

When the user desires to quickly remove the guide stud 110, the user depresses the plunger assembly 156. Depression of the plunger assembly 156 moves the pin 114 axially away from the first end 18 of the shank 12 (along axis A), which in turn, causes the outer surface 166 to again have the outer diameter “D”.

Advantageously, the guide studs 10, 110 have a length of about three or four inches, but can vary to suit the application. Further, the outer surface 16 of the shank 12 has an outer diameter which is sizeable to standard bolt dimensions. For example, the outer diameter of the shank 12 should be about 10 mm or less for a tapped hole that will accommodate a 10 mm (or M10) standard bolt.

While the guide studs 10, 110 incorporate generally cylindrical components, it is contemplated that non-cylindrical components can be used. A first maximum radial distance from the axis “A” to the outer surface of the gripper 58, 158 would dictate the clearance fit, and a second maximum radial distance from the axis “A” to the outer surface of the gripper 58, 158 would dictate the interference fit.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and the range of equivalency of the claims are to be embraced within their scope.

What is claimed is:

1. A guide stud, comprising:
a shaft;
a pin reciprocally disposed in the shaft, wherein the pin is substantially concentric with respect to the shaft, and wherein the pin is connected to a head portion;
a spring disposed between the shaft and the spring, wherein the spring is configured to apply a force between the shaft and the pin, wherein the guide stud is at an extended position when the force is high, and wherein the guide stud is at a retracted position when the force is lower;
a resilient gripper connected to a distal end of the shaft, wherein the gripper extends axially with respect to the shaft between the shaft and the head portion of the pin, wherein the gripper is disposed around at least a portion of the pin, wherein the gripper has an outer surface having a rest-state diameter and a deformed-state diameter that is larger than the rest-state diameter, wherein the outer surface is deformable to the deformed-state diameter when the pin is in the retracted position.

2. The guide stud of claim 1 wherein the gripper elastically returns to the rest-state diameter when the pin is in the extended position.

3. The guide stud of claim 1 wherein the gripper is configured to be engageable in an interference fit with a tapped hole when in the deformed-state.

4. The guide stud of claim 1 wherein the shaft has a first annular inner surface and a second annular inner surface, wherein the second inner surface has a larger diameter than the first inner surface, wherein the first and second inner surfaces are divided by a seat surface.

5. The guide stud of claim 4 further comprising a pin sleeve circumscribing the pin and adjustably fixed with respect to the pin, the pin sleeve being reciprocally received in the shaft.

6. The guide stud of claim 5 wherein the second inner surface, the seat surface, the pin sleeve, and the pin form an annular pocket, and wherein the spring is disposed in the annular pocket.

7. The guide stud of claim 1 wherein the gripper includes a generally tubular body, and wherein the head portion is integrated with the gripper.

8. The guide stud of claim 1 wherein the gripper includes a generally tubular body, and wherein the head portion is integrated with the pin.

9. The guide stud of claim 1 wherein the gripper is formed of rubber or plastic.

10. The guide stud of claim 1 further comprising:
a threaded portion on the pin; and
a spring adjuster that is disposed on the threaded portion and connected to a pin sleeve that circumscribes the pin.

11. A guide stud for quick insertion and withdrawal from a tapped hole, comprising:
a shaft having an outer surface;
a plunger assembly concentrically disposed within the shaft and defining an axis;
a spring configured to axially reciprocate the plunger assembly within the shaft, wherein the plunger assumes an extended position and a retracted position with respect to the shaft;
a resilient gripper having an additional outer surface that extends past the outer surface of the shaft at times when the plunger assembly is in the retracted position, wherein the additional outer surface has a first maximum radial distance to the axis, and wherein the gripper has a receiving structure configured for engaging the plunger assembly;
wherein at times when the plunger assembly is in the extended position, the plunger assembly extends into the receiving structure, and the first maximum radial distance is reduced.

12. The guide stud of claim 11, wherein at times when the plunger assembly is in the retracted position, the gripper is deformed radially outwardly with respect to the outer surface of the shaft.

13. The guide stud of claim 12, wherein the gripper is configured to be engageable in an interference fit with a tapped hole.

14. The guide stud of claim 11, wherein the shaft is generally tubular.

15. The guide stud of claim 11, wherein the gripper includes a generally tubular body and a head attached to the tubular body.

16. A guide stud for quick insertion and withdrawal from a threaded hole, comprising:
a shaft;
a plunger assembly concentrically disposed within the shaft and defining an axis;
a spring configured to axially reciprocate the plunger assembly in an extended and a retracted position with respect to a first end;
a resilient gripper extending axially with respect to the shaft and having an outer surface generally concentric to the axis when the plunger assembly is in the extended position;
wherein the outer surface is deformable and is configured to be engageable in an interference fit with the threaded hole when the plunger assembly is in the retracted position.

17. The guide stud of claim 16, wherein the plunger assembly comprises a pin concentrically disposed within the shaft, a pin sleeve concentrically disposed around the pin, wherein the pin and the pin sleeve are axially displaceable against the force of the spring.

18. The guide stud of claim 17, wherein the plunger assembly further comprises a head disposed at the end of the pin, wherein the head is attached to the gripper.

19. The guide stud of claim 16, wherein the shaft has a first annular inner surface and a second annular inner surface, wherein the second inner surface has a larger diameter than the first inner surface, wherein the first and second inner surfaces are divided by a seat surface.

20. The guide stud of claim 19 further comprising a pin sleeve circumscribing a pin and adjustably fixed with respect to the pin, the pin sleeve being reciprocally received in the shaft, wherein the second inner surface, the seat surface, the pin sleeve and the pin form an annular pocket for housing the spring.
